(19) United States
(12) Patent Application Publication
(10) Pub. No.: US 2022/0200268 A1
(43) Pub. Date: Jun. 23, 2022

(54) SOLID STATE CIRCUIT BREAKER

(71) Applicant: Hamilton Sundstrand Corporation, Charlotte, NC (US)

(72) Inventors: Yongduk Lee, Vernon, CT (US); Xin Wu, Glastonbury, CT (US); Bo Liu, Vernon, CT (US); Parag M. Kshirsagar, South Windsor, CT (US)

(73) Assignee: Hamilton Sundstrand Corporation, Charlotte, NC (US)

(21) Appl. No.: 17/133,499

(22) Filed: Dec. 23, 2020

(51) Int. Cl. H02H 7/09; H01H 71/12; H02H 3/087

(52) U.S. Cl. CPC H02H 7/09; H02H 3/087; H01H 71/123

(57) ABSTRACT

A solid state circuit breaker comprising, includes a first switch unit including, a first switch configured to be connected to a first terminal, a second switch connected to the first switch configured to be connected to a second terminal, a third switch connected to the second switch and configured to be connected to the second terminal, a fourth switch connected to the first switch and configured to be connected to the first terminal, and a fifth switch joining a connection of the first switch and the second switch to the connection of the third switch and the fourth switch.

### BACKGROUND

### Technological Field

The present disclosure relates generally to a solid-state circuit breaker, and more specifically to a solid-state circuit breaker with damping and precharging function capabilities.

### Description of Related Art

Aircraft commonly employ circuit breakers to protect on-board electrical hardware. More Electrical Airplane (MEA) try to equip solid-state circuit breakers (SSCB) to reduce the aircraft gross weight. SSCBs include high performance protection that includes quick disconnection response and very high blocking voltage. However, solid-state based protection systems have drawbacks, such as high conduction losses at the steady state being higher than power losses of contactor and mechanical circuit breaker, requiring complicated control and logics, and finally requiring complex networks of semiconductor switches. However multi-functions of SSCB would potentially offset the disadvantage, which is precharge and damping capability at short-circuit and over voltage. Thus, power losses can be being negligible. The present disclosure provides a solution for this need.

### SUMMARY OF THE INVENTION

A solid state circuit breaker includes a first switch unit having a first switch configured to be connected to a first terminal, a second switch connected to the first switch configured to be connected to a second terminal, a third switch connected to the second switch and configured to be connected to the second terminal, a fourth switch connected to the first switch and configured to be connected to the first terminal, a fifth switch joining a connection of the first switch and the second switch to the connection of the third switch and the fourth switch. A second switch unit can include a sixth switch configured to be connected to a third terminal, a seventh switch connected to the sixth switch configured to be connected to a fourth terminal, an eighth switch connected to the seventh switch and configured to be connected to the fourth terminal, a ninth switch connected to the sixth switch and configured to be connected to the third terminal, a tenth switch joining a connection of the sixth switch and the seventh switch to the connection of the eighth switch and the ninth switch.

A switch connecting the second switch unit and the first switch unit can include a pair of freewheeling diodes. Each of the switches can include a freewheeling diode. The first terminal can be connected to a converter side. The second terminal can be connected to an energy source (battery). The fifth switch can be closed in a pre-charging mode. The first switch can be closed in a discharging mode. The second switch can be closed in a charging mode. The fourth switch can be closed in a first terminal fault mode. The third switch can be closed in a second terminal fault mode. The fifth switch can be open in a fully disconnected mode. The fifth switch can include a resistor and an inductor. The solid-state circuit breaker can be part of a DC power network or be part of an AC power network.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a block diagram of an exemplary embodiment of solid-state circuit breaker of a DC system;

FIG. 2 is a block diagram of an exemplary embodiment of solid-state circuit breaker of an AC system;

FIG. 3 is a block diagram of an exemplary embodiment of solid-state circuit breaker of FIG. 1 in a pre-charging mode;

FIG. 4 is a block diagram of an exemplary embodiment of solid-state circuit breaker of FIG. 1 in a discharging of energy source (battery) mode or a steady state (conduction);

FIG. 5 is a block diagram of an exemplary embodiment of solid-state circuit breaker of FIG. 1 in a charging of energy source (battery) mode or a steady state (conduction);

FIG. 6 is a block diagram of an exemplary embodiment of solid-state circuit breaker of FIG. 1 in a converter side fault mode;

FIG. 7 is a block diagram of an exemplary embodiment of solid state circuit breaker of FIG. 1 in an energy source (battery) side fault mode; and

FIG. 8 is a block diagram of an exemplary embodiment of solid-state circuit breaker of FIG. 1 in a fully disconnected mode

### DETAILED DESCRIPTION

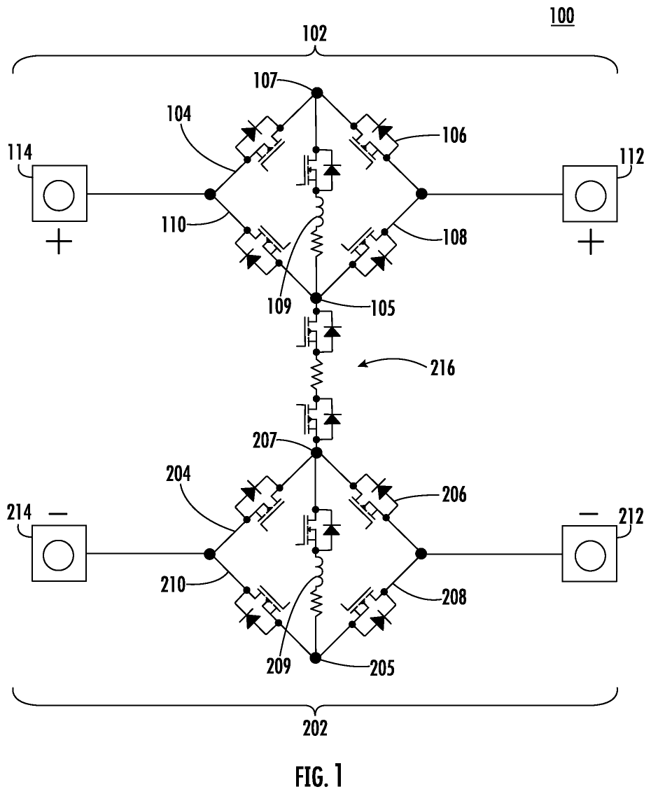

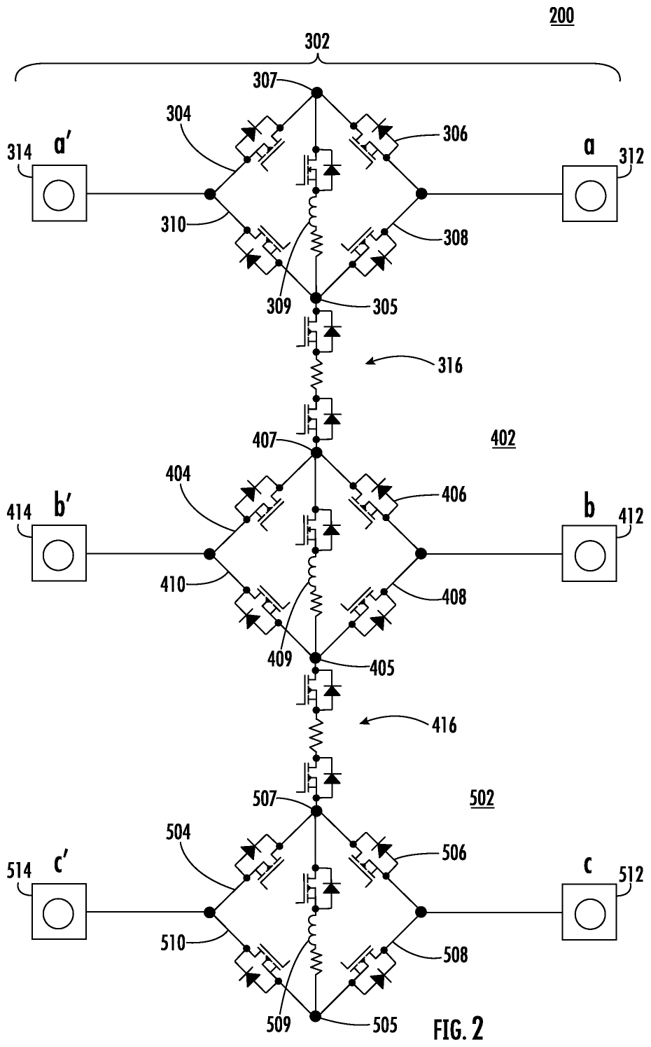

Reference will now be made to the drawings wherein like reference numerals identify similar structural features or aspects of the subject disclosure. For purposes of explanation and illustration, and not limitation, a partial view of an exemplary embodiment of a composite material in accordance with the disclosure is shown in FIG. 1 and is designated generally by reference character 10. Other embodiments of solid-state circuit breaker in accordance with the disclosure, or aspects thereof, are provided in FIGS. 2-8, as will be described. The solid state circuit breakers such composite material and electrical conductors described herein can be used for electrical systems and components for aircraft providing double current capacity and additional current path for more functions. Additional functions include:

1) Connection/disconnection with solid-state power switches

2) Fast disconnection response

3) Precharging function

4) Damping circuit to minimize the arcing voltage and the over voltage

5) Universal circuit breaker for ac/dc power network

6) High current capability by using full bridge type topology

7) Low voltage stress at transient by using bidirectional switches interface

FIG. 1 shows a solid-state circuit breaker 100 as part of a DC power network having two switch units 102/202. Each of the switch units 102/202 includes a first switch 104/204 connected to a first terminal 114/214, which is a converter side respectively. A second switch 106/206 is connected to the respective first switch 104/204 and connected to a respective second terminal 112/212, which is an energy source (battery) side. A third switch 108/208 is connected to the second switch 106/206 and connected to a respective second terminal 112/212. A fourth 110/210 switch is connected to the first switch 104/204 and connected to the respective first terminal 114/214. A fifth switch 109/209 joins a connection 107/207 of the respective first switches 104/204 and second switches 112/212 to the connection 105/205 of the respective third switches 108/208 and the fourth switch 110/210. A switch 116 and resistor 117 connects the switch units 102/202.

FIG. 2 shows a solid-state circuit breaker 200 as part of an AC power network having three phases having three switch units 302/402/502. Similarly, each of the switch units 302/402/502 includes a first switch 304/404/504 connected to a first terminal 314/414/514, which is part of a first phase respectively. A second switch 306/406/506 is connected to the respective first switch 304/404/505 and connected to a respective second terminal 312/412/512, which is a second phase. A third switch 308/408/508 is connected to the second switch 306/406/506 and connected to a respective second terminal 312/412/512. A fourth 310/410/510 switch is connected to the first switch 304/404/504 and connected to the respective first terminal 314/414/514. A fifth switch 309/409/509 joins a connection 307/407/507 of the respective first switches 304/404/504 and second switches 312/412/512 to the connection 305/405/505 of the respective third switches 308/408/508 and the fourth switch 310/410/510. Switches 316/416 connect the switch units 303/402/503 respectively.

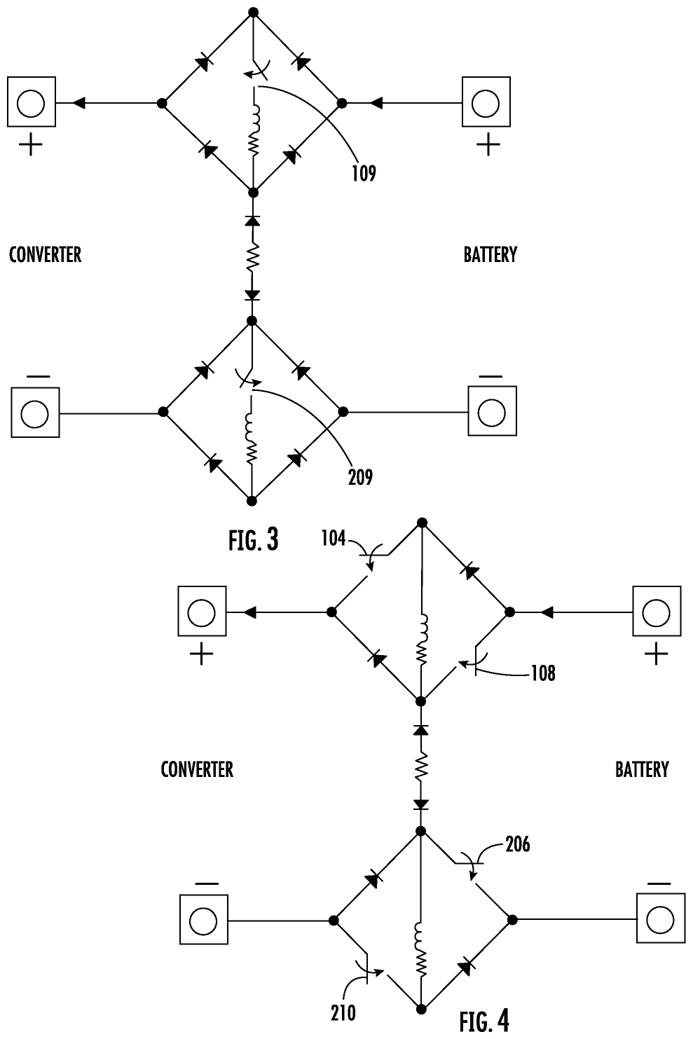

FIGS. 3-7 describe the DC system of FIG. 1, in various modes. FIG. 3 shows a pre-charging mode. In pre-charging mode, the fifth switches 109/209 are closed. Other switches are open. The current flows through the fifth switches 109/209 and resistor/inductor.

FIG. 4 shows a discharging mode with first switch 104 and third switch 108 of the first switch unit 102 closed and the second 206 and fourth switch 208 of the second switch unit 202 closed.

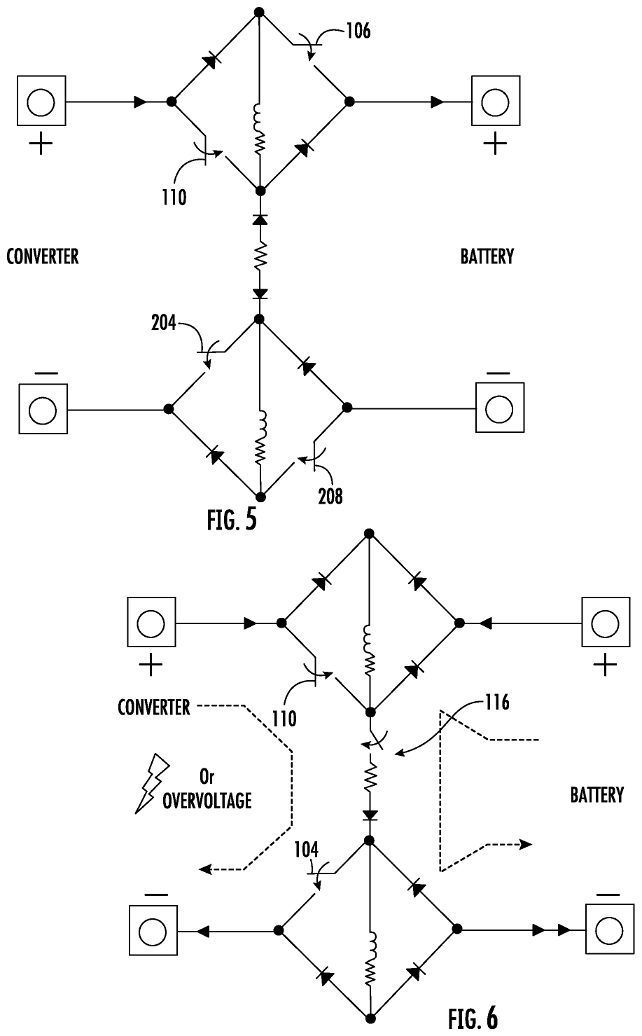

FIG. 5 shows a charging mode with first switch 204 and third switch 208 of the second switch unit 202 closed and the second 106 and fourth switch 108 of the first switch unit 102 closed.

FIG. 6 shows a converter side fault mode with the fourth switch 110 of the first switch unit 102 closed, switch 116 closed and first switch 204 of the second switch unit 202 closed.

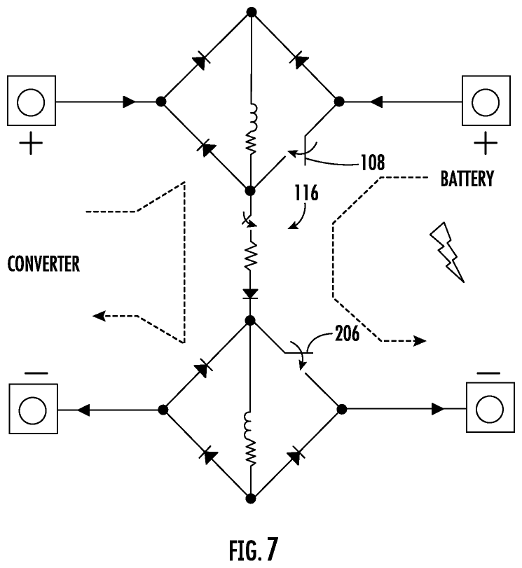

FIG. 7 shows a batter side fault with the third switch 108 of the first switch unit 102 and the second switch 206 of the second switch unit 202 closed, and switch 116 closed.

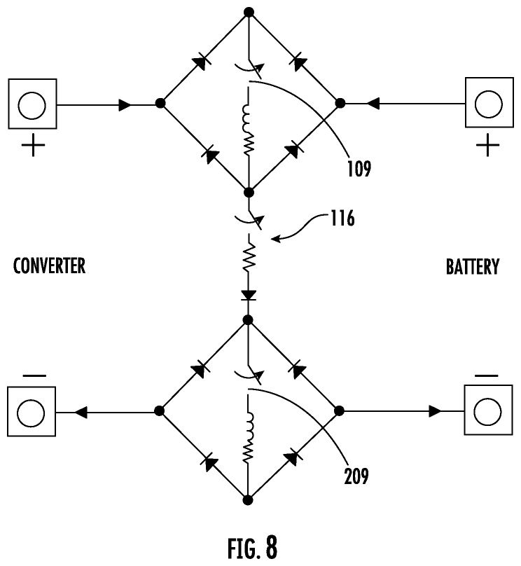

FIG. 8 shows a fully disconnected system with fifth switches 109/209 and switch 116 open as well.

While the apparatus and methods of the subject disclosure have been shown and described with reference to preferred embodiments, those skilled in the art will readily appreciate those changes and/or modifications may be made thereto without departing from the scope of the subject disclosure.

What is claimed is:

1. A solid state circuit breaker comprising:
a first switch unit including:
a first switch configured to be connected to a first terminal;
a second switch connected to the first switch configured to be connected to a second terminal;
a third switch connected to the second switch and configured to be connected to the second terminal;
a fourth switch connected to the first switch and configured to be connected to the first terminal; and
a fifth switch joining a connection of the first switch and the second switch to the connection of the third switch and the fourth switch.

2. The solid state circuit breaker of claim 1, further comprising:
a second switch unit including:
a sixth switch configured to be connected to a third terminal;
a seventh switch connected to the sixth switch configured to be connected to a fourth terminal;
an eighth switch connected to the seventh switch and configured to be connected to the fourth terminal;
a ninth switch connected to the sixth switch and configured to be connected to the third terminal; and
a tenth switch joining a connection of the sixth switch and the seventh switch to the connection of the eighth switch and the ninth switch.

3. The solid-state circuit breaker of claim 1, wherein a switch connecting the second switch unit and the first switch unit includes a pair of freewheeling diodes.

4. The solid-state circuit breaker of claim 1, wherein each of the switches includes a freewheeling diode.

5. The solid-state circuit breaks of claim 1, wherein the first terminal is connected to a converter side.

6. The solid-state circuit breaker of claim 1, wherein the second terminal is connected to an energy source.

7. The solid-state circuit breaker of claim 1, wherein the fifth switch is closed in a pre-charging mode.

8. The solid-state circuit breaker of claim 1, wherein the first switch is closed in a discharging mode.

9. The solid-state circuit breaker of claim 1, wherein the second switch is closed in a charging mode.

10. The solid-state circuit breaker of claim 1, wherein the fourth switch is closed in a first terminal fault mode.

11. The solid-state circuit breaker of claim 1, wherein the third switch is closed in a second terminal fault mode.

12. The solid-state circuit breaker of claim 1, wherein the fifth switch is open in a fully disconnected mode.

13. The solid-state circuit breaker of claim 1, wherein the fifth switch includes a resistor and an inductor.

14. The solid-state circuit breaker of claim 1, wherein the solid-state circuit breaker is part of a DC power network.

15. The solid-state circuit breaker of claim 1, wherein the solid-state circuit breaker is part of an AC power network.
